(19) United States
(12) Patent Application Publication
(10) Pub. No.: US 2026/0056036 A1
(43) Pub. Date: Feb. 26, 2026

(54) SCALE

(71) Applicant: RENISHAW PLC, Wotton-under-Edge, Gloucestershire (GB)

(72) Inventors: James Reynolds HENSHAW, Wotton-under-Edge (GB); Finlay Jonathan EVANS, Wotton-under-Edge (GB); George Frederick BRAMTON, Wotton-under-Edge (GB)

(73) Assignee: RENISHAW PLC, Wotton-under-Edge, Gloucestershire (GB)

(21) Appl. No.: 19/100,207

(22) PCT Filed: Aug. 7, 2023
(86) PCT No.: PCT/GB2023/052079

§ 371 Date: Jan. 31, 2025

(30) Foreign Application Priority Data
Aug. 9, 2022 (GB) 2211615.6

(51) Int. Cl. G01D 5/347

(52) U.S. Cl. CPC G01D 5/34707

(57) ABSTRACT

A scale arrangement for a measurement encoder includes a scale and a thermal displacement relief structure. The thermal displacement relief structure includes an intermediate member and a first thermal displacement relief layer for attaching the scale to the intermediate member. The coefficients of thermal expansion of the intermediate member and the scale conform to the following:

$$- 3 \times {10}^{- 6} {K}^{- 1} \leq CTE ( intermediate member ) - CTE ( scale ) \leq 6 \times {10}^{- 6} {K}^{- 1} .$$

The invention of the current application relates to a scale, more particularly to a metrological scale for use as part of a measurement encoder.

Metrological scales are used in the position measurement of a moving part of a machine relative to a stationary part. Metrological scale typically has a series of features on it which can be read by a readhead so that the readhead can provide a measure of its position along the scale. The metrological scale can be mounted onto the stationary or moving part of the machine and is read by a suitable readhead which is attached to the other of the stationary and moving part. Types of metrological scale include magnetic scales (in which the scale features are provided by features having particular magnetic properties), capacitive scales (in which the features are provided by features having particular capacitive properties) and optical scales (in which the features are provided by features having particular optical properties). Optical scales can be transmissive or reflective. An example of an optical scale configuration is disclosed in EP 0207121 and also U.S. Pat. No. 4,974,962.

It is known to affix metrological scale to a part using an adhesive. It is common that the substrate on which the metrological scale is to be mounted and the metrological scale have different thermal expansion properties. One known method of mounting a scale to a substrate includes mastering the scale to the substrate. In such a method, the scale is fixed to the substrate so that the expansion and contraction of the scale is dictated by the expansion and contraction of the substrate, i.e., the scale is mounted in such a way that expansions and contraction of the substrate (such as thermal expansion) is transferred as much as possible to the scale.

In WO 2010/004248 a metrological scale is held against a substrate by a scale track. The disclosed track allows the metrological scale to expand and contract due to changes in temperature substantially independently of the substrate.

JP H05269650 discloses an arrangement where a reduction in position detecting accuracy due to thermal expansion of the substrate is intended to be prevented by mounting a main scale on a mounting member using an elastic material which reduces in volume upon hardening and which, even after hardening remains elastic.

U.S. Pat. No. 7,007,397 discloses a glass epoxy board scale mounted by a thin layer of powerful adhesive such as an epoxy type adhesive to a metal tape in order that the thermal expansion characteristics of the scale are dominated by the metal tape. The metal tape is mounted to a substrate via a relief structure for thermal displacement.

According to a first aspect of invention there is provided a scale arrangement for a measurement encoder, the scale arrangement comprising a scale and a thermal displacement relief structure, the thermal displacement relief structure comprising an intermediate member, a first thermal displacement relief layer, and a second thermal displacement relief layer, the first thermal displacement relief layer for attaching the scale to the intermediate member, wherein the coefficients of thermal expansion of the intermediate member and of the scale conform to:

$$- 3 \times {10}^{- 6} {K}^{- 1} \leq CTE ( intermediate member ) - CTE ( scale ) \leq 6 \times {10}^{- 6} {K}^{- 1} .$$

By providing such a scale arrangement, the effect of the thermal expansion behaviour of a substrate on which the scale arrangement may be located can be reduced. This can provide improved scale behaviour during temperature changes.

Optionally the coefficients of thermal expansion of the intermediate member and of the scale conform to:
−2×10⁻⁶ K⁻¹≤CTE(intermediate member)−CTE(scale)≤2×10⁻⁶ K⁻¹, optionally: −2×10⁻⁶ K⁻¹≤CTE(intermediate member)−CTE(scale)≤1.6×10⁻⁶ K⁻¹, for instance: −1×10⁻⁶ K⁻¹≤CTE(intermediate member)−CTE(scale)≤1×10⁻⁶ K⁻¹

Optionally the coefficients of thermal expansion of the intermediate member and of the scale confirm to:

$$- 0.2 \times {10}^{- 6} {K}^{- 1} \leq CTE ( intermediate member ) - CTE ( scale ) \leq 0.2 \times {10}^{- 6} {K}^{- 1}$$

Optionally the thermal displacement relief structure is for attaching the scale to a substrate. Optionally the coefficient of thermal expansion of the intermediate member is the inherent coefficient of thermal expansion of the material which the intermediate member comprises. Optionally the coefficient of thermal expansion of the scale is the inherent coefficient of thermal expansion of the material which the scale comprises.

Optionally the second thermal displacement relief layer is for attachment of the scale to the substrate, for example via the intermediate member. Optionally the second thermal displacement relief layer is for attachment of the intermediate member to the substrate.

Optionally the first and/or second thermal displacement relief layer exhibit an elastic response, for example an elastic response to sheer which may be brought about by thermal expansion, for example thermal expansion of the scale and/or the intermediate member in the case of the first thermal displacement relief layer. Optionally the first and/or second thermal displacement relief layer is/are elastically deformable. Optionally the first thermal displacement relief layer couples the scale to the intermediate member. Optionally the scale is fastened to the intermediate member by the first thermal displacement relief layer. Optionally the first and/or second thermal displacement relief layer comprises an adhesive tape. Optionally the first and/or second thermal displacement relief layer resist lateral movement of the scale and/or intermediate member, for example the first thermal displacement relief layer may resist lateral movement of the scale relative to the intermediate member, this can include lateral movement of the scale relative to the intermediate member in a direction orthogonal to both a measurement direction of the scale and a direction normal to the measurement face of the scale. Optionally the first thermal displacement relief layer and the second thermal displacement relief layer have the same thickness. Alternatively, the first thermal displacement relief layer and the second thermal displacement relief layer have different thicknesses, for example the second thermal displacement relief layer may be thicker than the first thermal displacement relief layer. The first thermal displacement relief layer may have the same width as the scale. The first thermal displacement relief layer may have the same width as the intermediate member. The first thermal displacement relief layer may have a width less than the scale. The first thermal displacement relief layer may have a width less than the intermediate member. The second thermal displacement relief layer may have the same width as the intermediate member. The second thermal displacement relief layer may have a width less than the intermediate member. The first thermal displacement relief layer may have the same width as the second thermal displacement relief layer. Alternatively, the first thermal displacement relief layer and the second thermal displacement relief layer may have different widths, for example, the first thermal displacement relief layer may have a larger width than the second thermal displacement relief layer may. The first thermal displacement relief layer and the second thermal displacement relief layer may comprise a unitary adhesive layer (for example, an adhesive tape), optionally where the first thermal displacement relief layer comprises a first region of the unitary adhesive layer which attaches the scale to the intermediate member and the second thermal displacement relief layer comprises a second region of the unitary adhesive layer for attaching the intermediate member to a substrate.

Optionally the scale comprises a metal or metal alloy. Optionally the intermediate member comprises a metal or metal alloy. Optionally the scale and intermediate member comprise the same metal or metal alloy. The metal or metal alloy could comprise an iron-nickel (“FeNi”) alloy, for example an alloy composition FeNi36.

Optionally the scale comprises glass or glass ceramic. Optionally the intermediate member comprises glass or glass ceramic. Optionally the scale and intermediate member comprise the same glass or glass ceramic. Optionally the intermediate member comprises carbon fibre. Optionally the scale arrangement is attached to a substrate. Optionally the scale arrangement is attached to a substrate via the intermediate member. Optionally the intermediate member is attached to a substrate via the second thermal displacement relief layer. Optionally the intermediate member is attached to a substrate via one or more clips/clamps or other mechanical constraint/fastener, such as the FASTRACK system available from Renishaw plc. The CTE of the intermediate member could be between the CTE of the scale and the CTE of the substrate, but of course this need not necessarily be the case.

Optionally the first thermal displacement relief layer is an adhesive layer.

Optionally the first thermal displacement relief layer is an adhesive layer which attaches the scale to the intermediate member. Optionally the second thermal displacement relief layer is an adhesive layer. Optionally the second thermal displacement relief layer is an adhesive layer for attaching the intermediate member to a substrate.

Optionally the first thermal displacement relief layer comprises an adhesive tape.

Optionally the second thermal displacement relief layer comprises an adhesive

Optionally the thermal displacement relief layers each comprise an adhesive tape. Tape. The adhesive tape may be a carrier tape provided on each of two faces with an adhesive layer.

Optionally the thermal displacement relief structure comprises more than one intermediate member. Optionally the second thermal displacement relief layer is an adhesive layer which attaches a first intermediate member to a second intermediate member. Optionally a third thermal displacement relief layer is an adhesive layer. Optionally the third thermal displacement relief layer is an adhesive layer for attaching the second intermediate member to a substrate.

Optionally the second intermediate member is attached to a substrate via one or more clips/clamps or other mechanical constraint/fastener.

The scale arrangement can be attached to the substrate by a thermal displacement relief layer which adheres an intermediate member (e.g. the aforesaid intermediate member, or the second intermediate member if present) of the thermal displacement relief structure to the substrate.

The intermediate member of thermal displacement that is directly adjacent the substrate (e.g. the aforesaid intermediate member, or the second intermediate member if present) can be fastened to the substrate by at least one mechanical fastener (thereby attaching the scale arrangement the substrate). The at least one mechanical fastener could act to clamp said intermediate member (e.g. the aforesaid intermediate member, or the second intermediate member if present) against the substrate. Optionally there is no adhesive and/or thermal displacement relief layer between said intermediate member and the substrate.

According to a second aspect of invention there is provided a scale arrangement for a measurement encoder, the scale arrangement comprising a metal or metal alloy scale and a thermal displacement relief structure, the thermal displacement relief structure comprising an intermediate member and a first thermal displacement relief layer for attaching the scale to the intermediate member, wherein the intermediate member comprises a metal or metal alloy and the thermal displacement relief structure comprises a second thermal displacement relief layer optionally for attaching the intermediate member to a substrate.

According to a third aspect of the invention there is provided a scale arrangement comprising a scale and a thermal displacement relief structure, the thermal displacement relief structure comprising a first intermediate member and a first thermal displacement relief layer for attaching the scale to the first intermediate member, and a second intermediate member and a second thermal displacement relief layer for attaching the first intermediate member to the second intermediate member. The scale can comprise a metal or metal alloy. The intermediate member can comprise a metal or metal alloy. The scale can comprise an iron-nickel (“FeNi”) alloy, in particular an alloy composition FeNi36. The second intermediate member can comprise carbon fibre.

According to a fourth aspect of the invention there is provided a scale arrangement for a measurement encoder, the scale arrangement comprising a scale and a thermal displacement relief structure, the thermal displacement relief structure comprising an intermediate member and a first thermal displacement relief layer for attaching the scale to the intermediate member, wherein the relative stiffness of the scale and the first thermal displacement relief layer is at least 0.33 m⁻².

According to a fifth aspect of invention there is provided a metrological scale comprising a scale bearing layer and an adhesive layer, the scale bearing layer comprising a material having a thickness of 50 μm to 1000 μm and a coefficient of thermal expansion of not more than 2×10⁻⁶ K⁻¹, the shear modulus of the adhesive layer being not more than 20 kPa. Optionally the scale is a linear scale.

According to a sixth aspect of invention there is provided a metrological scale comprising a scale bearing layer and an adhesive layer, the scale bearing layer comprising a material having a thickness of 50 μm to 1000 μm and a coefficient of thermal expansion of not more than 2×10⁻⁶ K⁻¹, and wherein when mounted to a substrate the thermal expansion behaviour of the scale bearing layer is dominated by the properties of the scale bearing layer. Optionally the substrate has a coefficient of thermal expansion from 5×10⁻⁶ K⁻¹ to 25×10⁻⁶ K⁻¹.

Optionally the substrate is granite, or iron, or steel, or aluminium. Optionally the substrate has thermal expansion properties between those of granite and aluminium.

Optionally the scale bearing layer comprises a nickel-iron alloy. The scale bearing layer may comprise FeNi36 (sometimes called 64FeNi and sold under as Invar(RTM)). Optionally the thickness of the scale bearing layer is not more than 900 μm, optionally not more than 800 μm, optionally not more than 700 μm, optionally not more than 600 μm, optionally not more than 500 μm, optionally not more than 400 μm, optionally not more than 300 μm, optionally not more than 200 μm. Optionally at least 100 μm. Optionally the thickness of the adhesive layer is not more than 0.2 mm.

According to a seventh aspect of invention there is provided a measurement encoder comprising a readhead and a scale according to the fifth aspect or the sixth aspect.

According to an eighth aspect of invention there is provided a machine comprising a scale according to the fifth aspect or the sixth aspect, or an encoder according to the seventh aspect. Optionally the machine comprises a CMM or a machine tool, display manufacturing equipment, or semiconductor processing equipment. Optionally the adhesive layer is directly attached to the machine.

According to a ninth aspect of invention there is provided a measurement encoder comprising a read head and a scale mounted to a substrate via an adhesive wherein the adhesive is arranged on a readhead facing face of the scale. Optionally a gap is provided between the scale and the substrate. The scale may be mounted to the substrate by height controlling elements.

By providing a measurement encoder comprising a read head and a scale mounted to a substrate via an adhesive wherein the adhesive is arranged on a readhead facing face of the scale the height of the readhead facing face of the scale relative to the substrate can be maintained even in the event the adhesive swells.

Features from the one aspect may be incorporated into other aspects.

Also disclosed is a scale arrangement for a measurement encoder. The scale arrangement may comprise a scale and a thermal displacement relief structure. The thermal displacement relief structure may comprise an intermediate member and a first thermal displacement relief layer for attaching the scale to the intermediate member. The thermal displacement relief structure may comprise a second thermal displacement relief layer. For the coefficient of thermal expansion of the intermediate member and scale the following may be true:

$$- 3 \times {10}^{- 6} {K}^{- 1} \leq CTE ( intermediate member ) - CTE ( scale ) \leq 6 \times {10}^{- 6} {K}^{- 1} .$$

Embodiments of the invention will now be described, by way of example only, with reference to the accompanying drawings, in which:

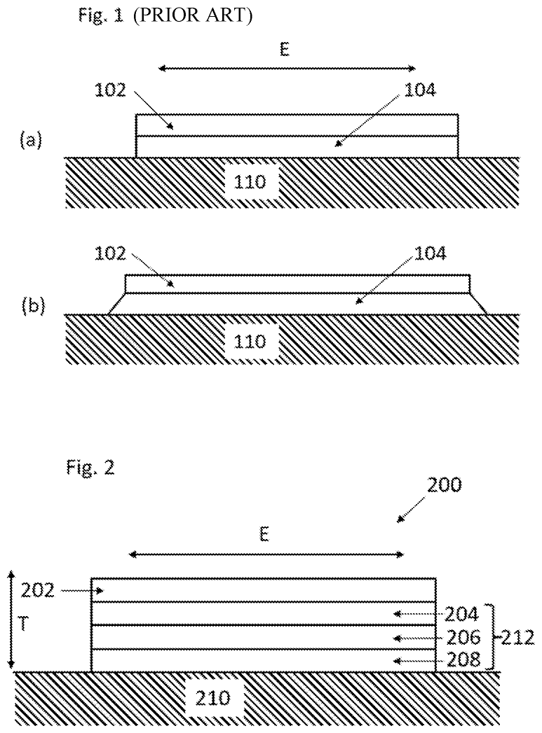

FIG. 1(a) shows a prior art arrangement where a scale is adhered to a substrate;

FIG. 1(b) shows the prior art arrangement of FIG. 1(a) at a higher temperature;

FIG. 2 shows a first scale arrangement mounted on a substrate;

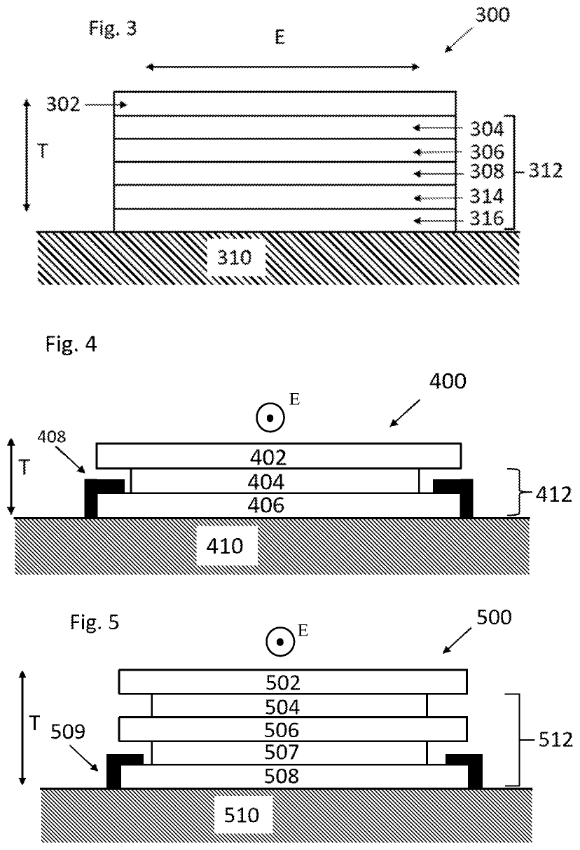

FIG. 3 shows an embodiment of a scale system mounted on a substrate;

FIG. 4 shows a second scale arrangement mounted on a substrate;

FIG. 5 shows a third scale arrangement mounted on a substrate;

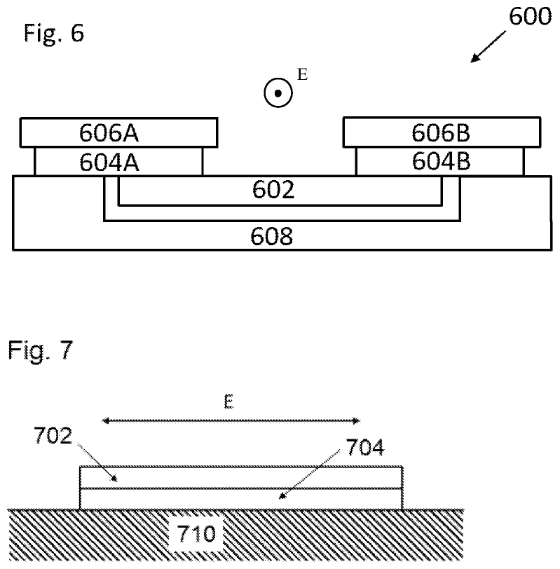

FIG. 6 shows a fourth scale arrangement;

And

FIG. 7 shows a fifth scale arrangement mounted on a substrate.

FIG. 1(a) shows a typical prior art arrangement where a metrological scale 102 is attached, via an adhesive layer 104 to a substrate 110 at a first temperature. The metrological scale 102 shown is an elongate metrological scale 102 having an elongate axis E. In use, the elongate axis E coincides with a measurement direction. The substrate 110 in this case may be aluminium, which has a coefficient of thermal expansion (CTE) in the range of 21 to 24×10⁻⁶ K⁻¹. The metrological scale 102 in this case is steel having a CTE of about 10×10⁻⁶ K⁻¹.

This means that for an increase in temperature of 1 K a steel scale will expand by 10 μm per metre of scale, whereas an aluminium substrate will expand by up to 24 μm per metre. For every 1 K temperature change a scale will want to increase its length by 14 μm per metre of scale less than an aluminium substrate. It will be appreciated that for longer scale lengths and/or larger temperature changes this difference will be larger in absolute terms.

FIG. 1(b) shows the arrangement of FIG. 1(a) at a second temperature, higher than the first temperature. In this case both the metrological scale 102 and substrate 110 have expanded due to the rise in temperature. In an example where the substrate 110 is an aluminium substrate 110 and the scale 102 is a steel scale 102, the aluminium substrate 110 has a higher CTE than the steel scale 102, therefore the aluminium substrate 110 expands by a greater amount than the steel scale 102. As the temperature increases, both the substrate 110 and the metrological scale 102 expand, however due to being connected by the adhesive layer 104 the expansion of the metrological scale 102 is influenced by the expansion of the substrate 110. This causes the effective CTE of the steel scale 102 to vary when compared to the inherent CTE(i.e., the CTE due to the temperature change alone) of the steel scale 102. In this case because the substrate 110 expands more than the steel scale 102 due to thermal expansion, the effective CTE of the steel scale 102 is increased relative to the inherent CTE of the steel scale 102. It has been found that for an aluminium substrate 110 having a CTE of 24×10⁻⁶ K⁻¹ a 3 m long (thermal datum to free end), 8 mm wide (in dimension parallel to the surface of the substrate 110), and 0.2 mm thick (in a dimension normal to the surface of the substrate 110) steel scale 102 having an inherent CTE of 10×10⁻⁶ K⁻¹, and where an adhesive layer has a thickness of 0.2 mm, a width of 6 mm, and a shear modulus of 1 kNm⁻², the effective CTE of the steel scale 102 is 12.8×10⁻⁶ K⁻¹.

The influence of the substrate 110 (transferred by the adhesive layer 104) has on the metrological scale 102 is dependent inter alia on the difference between the CTE of the metrological scale 102 and the CTE of the substrate 110, a degree of unpredictability may be introduced. For example, the substrate 110 need not be aluminium, the substrate 110 may be granite. As granite typically has a CTE of 7.8 to 8.4×10⁻⁶ K⁻¹, it will be appreciated that the influence on the metrological scale 102 caused by thermal expansion of a substrate 110 will be different for a granite substrate 110 when compared with an aluminium substrate 110. In fact, as granite has a lower CTE than steel, the change in effective CTE of a steel metrological scale 102 imparted by a granite substrate 110 would be negative (i.e. a compressive force would be applied) as the steel expands more than the granite substrate 110 due to a rise in temperature.

Thus, it may not always be possible to know the magnitude, or in fact the direction of any error introduced into a measurement arrangement due to a mismatch in CTE between a scale and a substrate.

FIG. 2 shows an exemplary embodiment of a scale arrangement 200 according to the invention. The scale arrangement 200 comprises a scale 202. In the scale arrangement 200 shown in FIG. 2, the scale 202 is attached to a substrate 210 via a thermal displacement relief structure 212. The thermal displacement relief structure 212 comprises a first adhesive layer 204, an intermediate member 206, and a second adhesive layer 208.

In this embodiment the scale 202 is a metrological scale 202. The scale 202 of FIG. 2 is an elongate scale 202 having an elongate axis E. In use, the elongate axis E coincides with a measurement direction. The scale 202 has markings which can be read by a readhead in order to determine a relative position. In this embodiment, the scale 202 is a steel scale 202.

Intermediate member 206 of the exemplary embodiment shown in FIG. 2 is identical to scale 202 but may not have markings which can be read by a readhead. The intermediate member 206 in this embodiment is made of the same material as the scale 202 and has the same dimensions (width, height, length) as the scale 202.

The first adhesive layer 204 and the second adhesive layer 208 shown in FIG. 2 are, in this embodiment the same and comprise an adhesive tape. The adhesive tape may be a carrier tape provided on each of two faces with an adhesive layer. Second adhesive layer 208 is non-rigid and can be deformed by a force (such as a shear force) imparted at a first interface (such as between substrate 210 and second adhesive layer 208) due to expansion of the substrate 210 due to a change in temperature. In this case, a material may be considered non-rigid if it has a low shear modulus. In this embodiment an adhesive tape is used which can be elastically stretched. The shear modulus of the adhesive tape is 1.2 kPa. At a second interface (such as between second adhesive layer 208 and intermediate member 206) a force is also applied due to the expansion of intermediate member 206 due to the change in temperate. If the expansion of the substate 210 and the expansion of the intermediate member 206 are not the same then the second adhesive layer 208 exerts a shear force on the intermediate member 206 due to the differential expansion of the substrate 210 which will influence the deformation behaviour of the intermediate member 206. Deformation of the second adhesive layer 208 due to thermal expansion of the substrate 210 and/or the intermediate member 206 is elastic. The first adhesive layer 204 is non-rigid and can be deformed by a force (such as a shear force), this can occur due to expansion of the intermediate member 206 expanding which causes deformation of the first adhesive layer at a third interface (such as between intermediate member 206 and first adhesive layer 204). In this embodiment an adhesive tape is used which can be elastically stretched. The shear modulus of the adhesive tape is 1.2 kPa. In the current embodiment, the intermediate member may have expanded due to a change in temperature and also because of a force due to differential thermal expansion of the substrate 210. The scale 202 will also have expanded due to the change in temperature. The scale 202 will also experience a force (such as a shear force) at a fourth interface (such as between the first adhesive layer 204 and the scale 202) if the expansion of the scale 202 due to the change in temperature and the expansion of the intermediate member 206 are different. The force acting on the scale 202 due to differential expansion of the scale 202 and intermediate member 206 will influence the deformation behaviour of the scale 202.

For an embodiment where the scale 202 is a steel scale 202 and the intermediate member 206 is steel intermediate member 206 and where the embodiment is located on an aluminium substrate 210, it will be appreciated that as the temperature of the scale arrangement 200 and substrate 210 changes, the difference in CTE values of the steel scale 202, steel intermediate member 206 and aluminium substrate 210 cause the aluminium substrate 210 to want to thermally expand to a different extent than the steel scale 202 and the steel intermediate member 206.

If the temperature of the scale arrangement 200 and substrate 210 is increased the aluminium substrate 210 will want to thermally expand to a greater extent than the steel intermediate member 206 or the steel scale 202. As the aluminium substrate 210 expands, the second adhesive layer 208 at the interface of the aluminium substrate 210 and the second adhesive layer 208 is deformed and causes a shear force to be applied at the interface between the second adhesive layer 208 and the steel intermediate member 206. The steel intermediate member 206 which has expanded due to the increase in temperature, is caused to expand further due to this shear force caused by differential thermal expansion of the intermediate member 206 and the substrate 210. In this embodiment the steel intermediate member 206 therefore has an effective CTE higher than the inherent CTE of the material from which the intermediate member 206 is made. Since the steel intermediate member 206 has expanded, the first adhesive layer 204 at the interface of the steel intermediate member 206 and the first adhesive layer 206 is deformed and this causes a shear force to be exerted at the interface between the first adhesive layer 204 and the steel scale 202. The steel scale 202 is caused to expand further due to this shear force caused by differential thermal expansion of the steel scale 202 and the steel intermediate member 206. In this embodiment the steel scale 202 therefore has an effective CTE higher than the inherent CTE of the material from which the scale 202 is made, but is lower than what it would be if it were directly attached to the substrate.

For a first embodiment comprising a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) steel scale 202 having an inherent CTE of 10×10⁻⁶ K⁻¹, a 3 m long (datum to free end in the measurement direction), 8 mm wide (in dimension parallel to the surface of the substrate 210 and perpendicular to the measurement direction), and 0.2 mm thick (in a dimension normal to the surface of the substrate 210) steel intermediate member 206 having an inherent CTE of 10×10⁻⁶ K⁻¹ and where the first adhesive layer 204 and second adhesive layer 208 are adhesive tapes having a thickness of 0.2 mm, a width of 6 mm, and a shear modulus of 1 kNm⁻², the effective CTE of the steel scale 202 is 10.56×10⁻⁶ K⁻¹ when the first embodiment is located on an aluminium substrate 210 having a CTE of 24×10⁻⁶ K⁻¹.

It can be seen that by introducing a steel intermediate member 206, the deviation of the CTE of the steel scale 202 from the inherent CTE of the material from which the steel scale 202 is made has been reduced when compared to the example described above in relation to the steel scale 102 of FIG. 1. In other words, an improvement in the behaviour of the scale 202 has been achieved because the effect of the differential expansion of the substrate and the scale has been reduced. A reduction in effective CTE of 2.24×10⁻⁶ K⁻¹ has been achieved by introducing steel intermediate member 206.

The first embodiment of the scale arrangement may be located on a different substrate, for example a granite substrate with an inherent CTE of 8×10⁻⁶ K⁻¹.

For the first embodiment comprising a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) steel scale 202 having an inherent CTE of 10×10⁻⁶ K⁻¹, a 3 m long (datum to free end in the measurement direction), 8 mm wide (in dimension parallel to the surface of the substrate 210 and perpendicular to the measurement direction), and 0.2 mm thick (in a dimension normal to the surface of the substrate 210) steel intermediate member 206 having an inherent CTE of 10×10⁻⁶ K⁻¹ and where the first adhesive layer 204 and second adhesive layer 208 are adhesive tapes having a thickness of 0.2 mm, a width of 6 mm, and a shear modulus of 1 kNm⁻², the effective CTE of the steel scale 202 is 9.9×10⁻⁶ K⁻¹ when the first embodiment is located on an granite substrate 210 having a CTE of 8×10⁻⁶ K⁻¹.

As can be seen from applying the first embodiment to an aluminium substrate and a granite substrate, in both cases when temperature changes the behaviour of the steel scale is closer to floating behaviour than to mastered behaviour. Pure floating behaviour would be when the thermal variation of temperature is independent of the substrate, in other words the effective CTE of the scale 202 would be the same as the inherent CTE of the material from which the scale 202 is made. Mastered behaviour would be when the scale is attached to the substrate in such a way that the thermal behaviour of the scale is dominated by the thermal behaviour of the substrate, if the scale were perfectly mastered to the substrate, then the effective CTE of the scale would be the inherent CTE of the material of the substrate.

For a second embodiment comprising a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) low expansion iron-nickel (“FeNi”) alloy (having an alloy composition FeNi36 and often referred to by the trade name Invar(RTM)) scale 202 having an inherent CTE of 1.0×10⁻⁶ K⁻¹, a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) low expansion FiNi alloy intermediate member 206 having an inherent CTE of 1.0×10⁻⁶ K⁻¹ and where the first adhesive layer 204 and second adhesive layer 208 are adhesive tapes having a thickness of 0.2 mm, a width of 6 mm, and a shear modulus of 1 kNm⁻², the effective CTE of the low expansion FeNi alloy scale 202 is 2.68×10⁻⁶ K⁻¹ when the second embodiment is located on an aluminium substrate 210 having a CTE of 24×10⁻⁶ K⁻¹. This compares to an effective CTE of 7.21×10⁻⁶ K⁻¹ when a low expansion FeNi alloy scale of the same dimensions is mounted on an aluminium substrate having a CTE of 24×10⁻⁶ K⁻¹ by a single adhesive tape having a thickness of 0.2 mm, a width of 6 mm and a shear modulus of 1 kPa. A reduction in effective CTE of 4.53×10⁻⁶ K⁻¹ has been achieved by introducing the low expansion FeNi alloy intermediate member 206.

When the second embodiment is located on a granite substrate 210 having a CTE of 8×10⁻⁶ K⁻¹ the effective CTE of the low expansion FeNi alloy scale 202 of the second embodiment is 1.51×10⁻⁶ K⁻¹. This compares to an effective CTE of 2.89×10⁻⁶ K⁻¹ when a low expansion FeNi alloy scale of the same dimensions is mounted on a granite substrate having a CTE of 8×10⁻⁶ K⁻¹ by an adhesive tape having a shear modulus of 1.2 kPa. A reduction in effective CTE of 1.38×10⁻⁶ K⁻¹ has been achieved by introducing the low expansion FeNi intermediate member 206.

While the first embodiment and the second embodiment comprise a scale 202 and intermediate member 206 made from the same material, and so have a substantially identical inherent CTE(within +/−3×10⁻⁶ K⁻¹, the invention can also be realised when the scale 202 and intermediate member 206 are made from different materials, for example where the inherent CTE values for the materials of the scale 202 and the intermediate member 206 are different.

Embodiments of the invention can comprise a scale arrangement where the scale 202 has an inherent CTE between the inherent CTE of intermediate member 206 and the substrate 210 to which the scale arrangement 200 is intended to be mounted. This can work well when the intermediate member 206 is disturbed by the substrate 210. The disturbed intermediate member 206 may then match the expansion of the scale 202 better than could be achieved when the scale 202 and intermediate member 206 have substantially similar inherent CTE values.

For a third embodiment comprising a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) steel scale 202 having an inherent CTE of 10×10⁻⁶ K⁻¹, a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) titanium intermediate member 206 having an inherent CTE of 8×10⁻⁶ K⁻¹ and where the first adhesive layer 204 and second adhesive layer 208 are adhesive tapes having a thickness of 0.2 mm, a width of 6 mm and a shear modulus of 1 kPa, the effective CTE of the steel scale 202 is 10.59×10⁻⁶ K⁻¹ when the third embodiment is located on an aluminium substrate 210 having a CTE of 24×10⁻⁶ K⁻¹. This compares to an effective CTE of 12.8×10⁻⁶ K⁻¹ when a steel scale of the same dimensions is mounted on an aluminium substrate having a CTE of 24×10⁻⁶ K⁻¹ by an adhesive tape having a thickness of 0.2 mm, a width of 6 mm and a shear modulus of 1 kPa A reduction in effective CTE of 2.24×10⁻⁶ K⁻¹ has been achieved by introducing the titanium intermediate member 206.

Embodiments of the invention can comprise a scale arrangement where the intermediate member 206 has an inherent CTE between the inherent CTE of scale 202 and the substrate 210 to which the scale arrangement 200 is intended to be mounted, but this need not necessarily be the case.

For a fourth embodiment comprising a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) steel scale 202 having an inherent CTE of 10×10⁻⁶ K⁻¹, a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) 3 series intermediate member 206 having an inherent CTE of 16×10⁻⁶ K⁻¹ and where the first adhesive layer 204 and second adhesive layer 208 are adhesive tapes having a thickness of 0.2 mm, a width of 6 mm and a shear modulus of 1 kPa, the effective CTE of the steel scale 202 is 11.54×10⁻⁶ K⁻¹ when the second embodiment is located on an aluminium substrate 210 having a CTE of 24×10⁻⁶ K⁻¹. This compares to an effective CTE of 12.8×10⁻⁶ K⁻¹ when a steel scale of the same dimensions is mounted on an aluminium substrate having a CTE of 24×10⁻⁶ K⁻¹ by an adhesive tape having a shear modulus of 1.2 kPa. A reduction in effective CTE of 1.26×10⁻⁶ K⁻¹ has been achieved by introducing the 3 series steel intermediate member 206.

For a fifth embodiment comprising a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) low expansion FeNi alloy (often sold as Invar(RTM)) scale 202 having an inherent CTE of 1×10⁻⁶ K⁻¹, a 3 m long (datum to free end in a measurement direction), 15 mm wide (in dimension parallel to the surface of the substrate 210 and perpendicular to the measurement direction), and 1.5 mm thick (in a dimension normal to the surface of the substrate 210) carbon fibre intermediate member 206 having an inherent CTE of −1×10⁻⁶ K⁻¹ and where the first adhesive layer 204 and second adhesive layer 208 are adhesive tapes having a thickness of 0.2 mm, a width of 6 mm and a shear modulus of 1 kPa, the effective CTE of the low expansion FeNi alloy scale 202 is 0.58×10⁻⁶ K⁻¹ when the fifth embodiment is located on an aluminium substrate 210 having a CTE of 24×10⁻⁶ K⁻¹. This compares to an effective CTE of 7.2×10⁻⁶ K⁻¹ when a low expansion FeNi alloy scale of the same dimensions is mounted on an aluminium substrate having a CTE of 24×10⁻⁶ K⁻¹ by an adhesive tape having a shear modulus of 1.2 kPa. A reduction in effective CTE of 6.7×10⁻⁶ K⁻¹ has been achieved by introducing the carbon fibre intermediate member 206.

When the fifth embodiment is located on a granite substrate 210 having a CTE of 8×10⁻⁶ K⁻¹ the effective CTE of the steel scale 202 of the fifth embodiment is 0.50×10⁻⁶ K⁻¹. This compares to an effective CTE of 2.90×10⁻⁶ K⁻¹ when steel scale of the same dimensions is mounted on a granite substrate having a CTE of 8×10⁻⁶ K⁻¹ by a single adhesive layer adhesive tape having a thickness of 0.2 mm, a width of 6 mm and a shear modulus of 1 kPa. A reduction in effective CTE of 2.40×10⁻⁶ K⁻¹ has been achieved by introducing the carbon fibre intermediate member 206.

For a sixth embodiment comprising a 3 m long (datum to free end in a measurement direction), 15 mm wide (in dimension parallel to the surface of the substrate 210 and perpendicular to the measurement direction), and 3 mm thick (in a dimension normal to the surface of the substrate 210) low expansion glass ceramic scale 202 sold as Robax (RTM) by Schott (RTM) having an inherent CTE of 0.5×10⁻⁶ K⁻¹, a 3 m long (datum to free end), 15 mm wide (in dimension parallel to the surface of the substrate 210), and 3 mm thick (in a dimension normal to the surface of the substrate 210) low expansion glass ceramic intermediate member 206 sold as Robax (RTM) having an inherent CTE of −0.5×10⁻⁶ K⁻¹ and where the first adhesive layer 204 and second adhesive layer 208 are adhesive tapes having a shear modulus of 1.2 kPa, the effective CTE of the Robax (RTM) scale 202 is 0.48× 10⁻⁶ K⁻¹ when the sixth embodiment is located on a granite substrate 210 having a CTE of 8×10⁻⁶ K⁻¹×. This compares to an effective CTE of 0.66×10⁻⁶ K⁻¹ when Robax scale of the same dimensions is mounted on a granite substrate having a CTE of 8×10⁻⁶ K⁻¹ by an adhesive tape having a thickness of 0.2 mm, a width of 6 mm and a shear modulus of 1 kPa. A reduction in effective CTE of 0.18×10⁻⁶ K⁻¹ has been achieved by introducing the Robax (RTM) intermediate member 206.

One factor which can influence the extent to which the scale 202 is disturbed by a mismatch between the CTE of the scale 202 and the CTE of the substrate 210 on which the scale arrangement 200 is located is the stiffness of the intermediate member 206. As discussed above, as the temperature increases the substrate 210 expands and this can cause a force to be transferred through the second adhesive layer 208 which can (in the case of the substrate 210 having a higher inherent CTE compared to the CTE of the intermediate member 206) cause stretching of the intermediate member 206. As the stiffness of the intermediate member 206 increases, the disturbance caused by the mismatch in inherent CTE values of the substrate 210 and the intermediate member 206 is reduced.

For a seventh embodiment comprising a 3 m long (datum to free end in a measurement direction), 8 mm wide (in dimension parallel to the surface of the substrate 210 and perpendicular to the measurement direction), and 0.2 mm thick (in a dimension normal to the surface of the substrate 210) steel scale 202 having an inherent CTE of 10×10⁻⁶ K⁻¹, a 3 m long (datum to free end), 8 mm wide (in dimension parallel to the surface of the substrate 210), and 0.1 mm thick (in a dimension normal to the surface of the substrate 210) titanium intermediate member 206 having an inherent CTE of 8×10⁻⁶ K⁻¹ and where the first adhesive layer 204 and second adhesive layer 208 are adhesive tapes having a thickness of 0.2 mm, a width of 6 mm and a shear modulus of 1 kPa, the effective CTE of the steel scale 202 is 11.1×10⁻⁶ K⁻¹ when the seventh embodiment is located on an aluminium substrate 210 having a CTE of 24×10⁻⁶ K⁻¹. This compares to an effective CTE of 12.8×10⁻⁶ K⁻¹ when a steel scale of the same dimensions is mounted on an aluminium substrate having a CTE of 24×10⁻⁶ K⁻¹ by an adhesive tape having a thickness of 0.2 mm, a width of 6 mm and a shear modulus of 1 kPa. A reduction in effective CTE of 1.77×10⁻⁶ K⁻¹ has been achieved by introducing the titanium intermediate member 206.

The difference between the third embodiment and the seventh embodiment is the thickness (in a dimension normal to the surface of the substrate 210) of the titanium intermediate member 206. The titanium intermediate member 206 of the seventh embodiment is half the thickness (in a dimension normal to the surface of the substrate 210) of the titanium intermediate member 206 in the third embodiment, and therefore half the stiffness. The third embodiment achieving a reduction in effective CTE of 2.24×10⁻⁶ K⁻¹, while the seventh embodiment achieves a reduction in effective CTE of 1.76×10⁻⁶ K⁻¹. It can therefore be seen that the stiffness of the intermediate member 206 can be used to tune the behaviour of the scale 202.

For an eighth embodiment comprising a 3 m long (datum to free end in a measurement direction), 15 mm wide (in dimension parallel to the surface of the substrate 210 and perpendicular to the measurement direction), and 3 mm thick (in a dimension normal to the surface of the substrate 210) low expansion inorganic non-porous lithium aluminium silicon oxide glass ceramic scale 202 sold as Zerodur (RTM) having an inherent CTE of 0×10⁻⁶ K⁻¹, a 3 m long (datum to free end in a measurement direction), 15 mm wide (in dimension parallel to the surface of the substrate 210 and perpendicular to the measurement direction), and 0.2 mm thick (in a dimension normal to the surface of the substrate 210) Invar(RTM) intermediate member 206 having an inherent CTE of 1×10⁻⁶ K⁻¹ and where the first adhesive layer 204 and second adhesive layer 208 are adhesive tapes having a thickness of 0.2 mm, a width of 6 mm and a shear modulus of 1 kPa, the effective CTE of the Zerodur (RTM) scale 202 is 0.048×10⁻⁶ K⁻¹ when the eighth embodiment is located on a granite substrate 210 having a CTE of 8×10⁻⁶ K⁻¹ This compares to an effective CTE of 0.17×10⁻⁶ K⁻¹ when Zerodur (RTM) scale of the same dimensions is mounted on a granite substrate having a CTE of 8×10⁻⁶ K⁻¹ by an adhesive tape having a thickness of 0.2 mm, a width of 6 mm and a shear modulus of 1 kPa. A reduction in effective CTE of 0.13×10⁻⁶ K⁻¹ has been achieved by introducing the Invar intermediate member 206. This is a 70% reduction in effective CTE.

For an ninth embodiment comprising a 3 m long (datum to free end in a measurement direction), 15 mm wide (in dimension parallel to the surface of the substrate 210 and perpendicular to the measurement direction), and 3 mm thick (in a dimension normal to the surface of the substrate 210) glass ceramic scale 202 sold as Zerodur (RTM) having an inherent CTE of 0×10⁻⁶ K⁻¹, a 3 m long (datum to free end in a measurement direction), 6 mm wide (in dimension parallel to the surface of the substrate 210 and perpendicular to the measurement direction), and 0.05 mm thick (in a dimension normal to the surface of the substrate 210) Invar (RTM) intermediate member 206 having an inherent CTE of 1×10⁻⁶ K⁻¹ and where the first adhesive layer 204 and second adhesive layer 208 are adhesive tapes having a thickness of 0.2 mm, a width of 6 mm and a shear modulus of 1 kPa, the effective CTE of the Zerodur (RTM) scale 202 is 0.114×10⁻⁶ K⁻¹ when the ninth embodiment is located on a granite substrate 210 having a CTE of 8×10⁻⁶ K⁻¹. This compares to an effective CTE of 0.17×10⁻⁶ K⁻¹ when Zerodur (RTM) scale of the same dimensions is mounted on a granite substrate having a CTE of 8×10⁻⁶ K⁻¹ by an adhesive tape having a thickness of 0.2 mm, a width of 6 mm and a shear modulus of 1 kPa. A reduction in effective CTE of 0.06×10⁻⁶ K⁻¹ has been achieved by introducing the Invar(RTM) intermediate member 206. This is a 34% reduction in effective CTE.

For the eighth embodiment the value of the stiffness of the intermediate member divided by the stiffness of the scale is 0.104, while in the ninth embodiment the value of the stiffness of the intermediate member divided by the stiffness of the scale is 0.0138. It can be seen that an improvement in the behaviour of the scale member 202 can be achieved even when the stiffness of the intermediate member 206 is much less than the stiffness of the scale 202.

Another factor which can influence the performance of the scale arrangement 200 is the ability of the first adhesive layer 204 and second adhesive layer 208 to generate forces at a second interface (such as the interface between the first adhesive layer 204 and the scale 202) for a given expansion of a first interface (such as the interface between the intermediate member 206 and the first adhesive layer 204). This can be measured as a shear stiffness per unit length k. The higher the value of k, the more effective the adhesive layer is at generating forces at a second interface for a given expansion of a first interface.

The shear stiffness per unit length of the adhesive tape can be calculated by multiplying the adhesive tape's shear modulus by its thickness and then by dividing by its width.

As discussed above, the amount the intermediate member 206 is disturbed by expansion of the substrate 210 due to a CTE mismatch is related to the forces generated at the interface between the intermediate 206 and the second adhesive layer 208 due to the stretching of the second adhesive layer 208 at the interface between the second adhesive layer 208 and the substrate 210. The amount of disturbance of the intermediate member 206 for a particular case is therefore based on the ability of the second adhesive layer 208 to generate forces at a second interface due to stretching at a first interface (shear stiffness, k), and on the extent to which the intermediate member 206 is influenced by the force (stiffness of the intermediate member 206).

The stiffness of the intermediate member 206 can be calculated by taking the product of the Young's modulus (E) of the material and the cross sectional area (A) of the intermediate member 206.

The relative stiffness (R) of the intermediate member 206 and the second adhesive layer 208 which generates forces at the interface between the second adhesive layer 208 and the intermediate member 206 due to the expansion of the substrate 210 can be defined as the stiffness (EA) of the intermediate member 206 divided by the shear stiffness per unit length (k) of the second adhesive layer 208.

$$R = EA / k$$

For example, for the first embodiment R=11.2 m⁻².

For embodiments where R=0.27 m⁻² (for either the scale 202 and first adhesive layer 204 or for the intermediate member and second adhesive layer 206) then the scale 202 of a 1 m long scale arrangement will be halfway between floating and mastered (the effective CTE of the scale will be halfway between the inherent CTE of the material from which the scale 202 is made and the inherent CTE of the material from which the substrate is made). For shorter lengths, the scale 202 will have an effective CTE closer to the inherent CTE of the material of the scale than the CTE of the substrate 210. Longer lengths of scale will exhibit effective CTEs closer to the inherent CTE of the substrate 210.

For embodiments where R=1 m⁻² for either the scale 202 and first adhesive layer 204 or for the intermediate member and second adhesive layer 206) then a 2 m axis will be halfway between floating and mastered to 1 significant figure. Shorter lengths, the scale 202 will have an effective CTE closer to the inherent CTE of the material of the scale than the CTE of the substrate 210.

It has been found that for typical scale lengths, a value of the relative stiffness (R) of the intermediate member 206 and the second adhesive layer 208, or the relative stiffness (R) of the scale 202 and the first adhesive layer 204, being 0.33 m⁻² or greater provides substantial improvement.

When the relative stiffness of at least one of the relative stiffness (R) of the intermediate member 206 and the second adhesive layer 208 or the scale 202 and the first adhesive layer 204 is 1 m⁻² or greater, significant improvement in the performance of the scale 202 is seen.

For an tenth embodiment comprising a 2 m long (datum to free end in a measurement direction), 8 mm wide (in dimension parallel to the surface of the substrate 210 and perpendicular to the measurement direction), and 0.18 mm thick (in a dimension normal to the surface of the substrate 210) steel scale 202 having an inherent CTE of 10×10⁻⁶ K⁻¹, a 2 m long (datum to free end in a measurement direction), 8 mm wide (in dimension parallel to the surface of the substrate 210 and perpendicular to the measurement direction), and 0.18 mm thick (in a dimension normal to the surface of the substrate 210) steel intermediate member 206 having an inherent CTE of 10×10⁻⁶ K⁻¹ and where the first adhesive layer 204 and second adhesive layer 208 are adhesive tapes having a thickness of 0.2 mm, a width of 6 mm and a shear modulus of 10 kPa giving R=1 m⁻² for each layer, the effective CTE of the steel scale 202 is 10.796×10⁻⁶ K⁻¹ when the tenth embodiment is located on an aluminium substrate 210 having a CTE of 24×10⁻⁶ K⁻¹. This compares to an effective CTE of 13.3×10⁻⁶ K⁻¹ when steel scale of the same dimensions is mounted on an aluminium substrate having a CTE of 24×10⁻⁶ K⁻¹ by an adhesive tape having a thickness of 0.2 mm, a width of 6 mm and a shear modulus of 10 kPa. A reduction in effective CTE of 2.54×10⁻⁶ K⁻¹ has been achieved by introducing the steel intermediate member 206.

While the above embodiments have been described with respect to the scale arrangement as shown in FIG. 2, other embodiments may comprise alternative configurations for the thermal displacement relief structure of the scale arrangement.

FIG. 3 shows an exemplary configuration of a scale arrangement 300 according to the invention. The scale arrangement 300 comprises a scale 302. In the scale arrangement 300 shown in FIG. 3, the scale 302 is attached to a substrate 310 via a thermal displacement relief structure 312. The thermal displacement relief structure 312 comprises a first adhesive layer 304, a first intermediate member 306, a second adhesive layer 308, a second intermediate member 314, and a third adhesive layer 316.

In this embodiment the scale 302 is a metrological scale 302. The scale 302 of FIG. 3 is an elongate scale 302 having an elongate axis E. In use, the elongate axis E coincides with a measurement direction. The scale 302 has markings which can be read by a readhead in order to determine a relative position.

The first adhesive layer 304, the second adhesive layer 308, and the third adhesive layer 316 shown in FIG. 3 are non-rigid and can be stretched. A force (such as a shear force) imparted due to stretching at a first interface (such as between substrate 310 and third adhesive layer 316) causes a force to act at a second interface (such as between the third adhesive layer 316 and the second intermediate member 214). Deformation of the third adhesive layer 316 due to thermal expansion of the substrate 310 and/or the second intermediate member 314 is elastic. Deformation of the second adhesive layer 308 and/or the first intermediate member 306 is elastic. The first adhesive layer 304 is a thermal displacement relief layer. The second adhesive layer 308 is a thermal displacement relief layer. The third adhesive layer is a thermal relief layer. In this case, a material may be considered non-rigid if it has a low shear modulus. For example, each of the first adhesive layer 304, and/or second adhesive layer 308, and/or third adhesive layer 316 may an adhesive tape having a shear modulus of 1 kPa.

In a particularly preferred embodiment, the scale arrangement comprises a scale (e.g. 302) and a first intermediate member (e.g. 306) which both comprise/are made from low-expansion FeNi alloy (having an alloy composition FeNi36 and often referred to by the trade name Invar(RTM)) having an inherent CTE of 1.0×10⁻⁶ K⁻¹, and wherein the scale arrangement further comprises a second intermediate member (e.g. 314) which comprises/is made from carbon fibre having an inherent CTE of −1×10⁻⁶ K⁻¹. As per the above-described embodiments, a first thermal displacement layer (e.g. first adhesive layer 304) is provided between the scale and first intermediate member, and a second thermal displacement layer (e.g. second adhesive layer 308) is provided between the first and second intermediate members. The second intermediate member (i.e. in this embodiment, the carbon fibre layer) can be mounted to the substrate via an adhesive layer or could be clamped to the substrate. The compound structure of multiple layers of low-expansion FeNi as described above enables thinner and therefore cheaper and lighter scales made from low-expansion FeNi alloy without sacrificing metrological performance. Furthermore, the high specific stiffness of the carbon fibre aids in the handling of the FeNi alloys scale reducing risk of damage if not properly supported, for example during installation. In an optional embodiment, the width of second intermediate member (i.e. in this embodiment, the carbon fibre layer) can be wider than the layers above it. This can be beneficial for mechanical handling and/or clamping purposes.

FIG. 4 shows an exemplary configuration of a scale arrangement 400 according to the invention. In FIG. 4, the elongate axis E extends into/out-of the page. The scale arrangement 400 comprises a scale 402. In the scale arrangement 400 shown in FIG. 4, the scale 402 is attached to a substrate 410 via a thermal displacement relief structure 412. The thermal displacement relief structure 412 comprises an adhesive layer 404, and an intermediate member 406. In scale arrangement 400 shown in FIG. 4 is elongate and has an elongate measurement direction perpendicular to the plane of the page.

In this embodiment the scale 402 is a metrological scale 402. The scale 402 of FIG. 4 is an elongate scale 402. FIG. 4 shows a cross section of the scale orthogonal to an elongate axis of the scale 402. In use, the elongate axis coincides with a measurement direction. The scale 402 has markings which can be read by a readhead in order to determine a relative position.

The adhesive layer 404 shown in FIG. 4 is non-rigid and can be stretched, i.e., a force (such as a shear force) imparted due to stretching at a first interface (such as between intermediate member 406 and adhesive layer 404) causes a force to act at a second interface (such as between the adhesive layer 404 and the scale 402). Deformation of the adhesive layer 404 due to thermal expansion of the intermediate member 406 and/or the scale 402 is elastic. The adhesive layer 404 is a thermal displacement relief layer. In this case, a material may be considered non-rigid if it has a low shear modulus. Here the adhesive tape can be elastically stretched. For example, the shear modulus of the adhesive tape that forms first adhesive layer 404 may be 1 kPa.

Clips 408 are located at each side of the scale arrangement 400 and in use hold the intermediate member 406 against the substrate.

In the configuration shown in FIG. 4 a mismatch in inherent CTE of the substrate 410 and the inherent CTE of the intermediate member 406 may cause the intermediate member 406 to have an effective CTE which differs from the inherent CTE of the intermediate member 406 due to frictional forces between the intermediate member 406 and the substrate, and/or frictional forces between the intermediate member 406 and the clips 408. These frictional forces can arise when the substrate 410 and intermediate member 406 expand at different rates due to a change in temperature, or mechanical distortion of the scale or substrate.

In some embodiments, intermediate member 406 may comprise carbon fibre.

FIG. 5 shows an exemplary configuration of a scale arrangement 500 according to the invention. In FIG. 5, the elongate axis E extends into/out-of the page. The configuration shown in FIG. 5 is similar to the configuration shown in FIG. 4 with the exception of the thermal displacement relief structure 512. The configuration of the thermal displacement relief structure of FIG. 5 comprises a first adhesive layer 504, a first intermediate member 506, a second adhesive layer 507 and a second intermediate member 508. The scale arrangement 500 shown in FIG. 5 is attached to a substrate 510 by clips 509 which hold the second intermediate member 508 against the substrate 510. In some embodiments the second intermediate member 508 comprises carbon fibre.

FIG. 6 shows an exemplary configuration of a scale arrangement 600 according to the invention. The scale arrangement 600 comprises a scale 602. In the scale arrangement 600 shown in FIG. 6, the scale 602 is attached to a thermal displacement relief structure. The thermal displacement relief structure comprises a first adhesive layer 604A which is a thermal relief layer, and which attaches the scale 602 to a first intermediate member 606A. The thermal displacement relief structure further comprises a second adhesive layer 604B which is a thermal relief layer attaches the scale 602 to a second intermediate member 606B.

In some embodiments the first adhesive layer 604A and the second adhesive layer 604B also attach the scale to a substrate 608. In other embodiments scale 602 is attached to substrate 608 via a via thermal a displacement relief structure comprising adhesive layer 604A and intermediate member 606A but without second adhesive later 604B or second intermediate member 606B.

In other embodiments the first adhesive layer 604A and the second adhesive layer 604B also attach the scale to an intermediate member 608. In some embodiments the intermediate member 608 comprises carbon fibre. The scale arrangement 600 shown in FIG. 6 can be attached to a substrate, for example via a third adhesive layer (which may be a thermal relief layer) or by clips, or by any other attachment method known to the skilled person.

FIG. 7 shows an exemplary configuration of a scale arrangement to the invention. The scale arrangement comprises a scale 702. In the scale arrangement shown in FIG. 7, the scale 702 is attached an adhesive layer 704 which attaches the scale 702 to a substrate 710. In this embodiment the scale 702 is a low CTE scale, in particular a FeNi36 (sometimes called 64FeNi or Invar(RTM)) scale, having a thickness (in a direction normal to the substrate) of 200 μm. The adhesive layer is an adhesive tape having a thickness (in a direction normal to the substrate) of 0.2 mm, and a shear modulus of 1 kPa when the adhesive tape has a width of 6 mm. In other embodiments the adhesive layer may comprise two or more layers of adhesive tape. In further embodiments the thickness of each of the or each layer of adhesive tape may not be 0.2 mm, for example the thickness of each layer of adhesive tape may be more than or less than 0.2 mm.

1. A scale arrangement for a measurement encoder, the scale arrangement comprising a scale and a thermal displacement relief structure, the thermal displacement relief structure comprising an intermediate member, a first thermal displacement relief layer, and a second thermal displacement relief layer, the first thermal displacement relief layer for attaching the scale to the intermediate member, wherein the coefficients of thermal expansion of the intermediate member and the scale conform to the following:
$$- 3 \times {10}^{- 6} {K}^{- 1} \leq CTE ( intermediate member ) - CTE ( scale ) \leq 6 \times {10}^{- 6} {K}^{- 1} .$$

2. A scale arrangement as claimed in claim 1 wherein the second thermal displacement relief layer is for attachment of the scale to a substrate.

3. A scale arrangement as claimed in claim 2 wherein the second thermal displacement relief layer is for attachment of the intermediate member to the substrate.

4. A scale arrangement as claimed in claim 1 wherein the scale comprises a metal or metal alloy.

5. A scale arrangement as claimed in claim 1 wherein the intermediate member comprises a metal or metal alloy.

6. A scale arrangement as claimed in claim 1 wherein the scale comprises a glass or glass ceramic.

7. A scale arrangement as claimed in claim 6 wherein the intermediate member comprises a glass or glass ceramic.

8. A scale arrangement as claimed in claim 1 wherein the intermediate member comprises carbon fibre.

9. A scale arrangement as claimed in claim 1, wherein the thermal displacement relief structure comprises a second intermediate member.

10. A scale arrangement as claimed in claim 9, comprising a second thermal displacement relief layer which attaches the intermediate member to the second intermediate member.

11. A scale arrangement as claimed in 10, wherein the scale comprises a metal or metal alloy, the intermediate member comprises a metal or metal alloy, and the second intermediate member comprises carbon fibre.

12. A scale arrangement as claimed in claim 3, wherein the metal or metal alloy comprises an iron-nickel (“FeNi”) alloy.

13. A scale arrangement as claimed in claim 1 wherein the relative stiffness of the scale and the first thermal displacement relief layer is at least 0.33 m⁻².

14. A scale arrangement as claimed in claim 2 wherein the relative stiffness of the intermediate member and the second thermal displacement relief layer is at least 0.33 m⁻².

15. A scale arrangement as claimed in claim 1 wherein the scale arrangement is attached to a substrate.

16. A scale arrangement as claimed in claim 14, wherein the scale arrangement is attached to the substrate by a thermal displacement relief layer which adheres an intermediate member of the thermal displacement relief structure to the substrate.

17. A scale arrangement as claimed in claim 15, wherein the intermediate member of the thermal displacement relief structure that is directly adjacent the substrate is fastened to the substrate by at least one mechanical fastener, thereby attaching the scale arrangement the substrate.

18. A scale arrangement as claimed in claim 17, wherein the at least one mechanical fastener acts to clamp said intermediate member against the substrate.

19. A scale arrangement as claimed in claim 17, wherein there is no adhesive and/or thermal displacement relief layer between said intermediate member and the substrate.

20. A scale arrangement as claimed in claim 9, wherein the second intermediate member is the intermediate member of the thermal displacement relief structure that lies directly on the substrate and on which the mechanical faster acts.

21.-24. (canceled)

25. A scale arrangement for a measurement encoder, the scale arrangement comprising a metal or metal alloy scale and a thermal displacement relief structure, the thermal displacement relief structure comprising an intermediate member, a first thermal displacement relief layer and a second thermal displacement relief layer, the first thermal displacement relief layer for attaching the scale to the intermediate member, wherein the intermediate member comprises a metal or metal alloy.

26.-27. (canceled)
